(19) United States
(12) Patent Application Publication
(10) Pub. No.: US 2026/0296456 A1
(43) Pub. Date: Oct. 1, 2026

(54) DRIVING ASSISTANCE CONTROL DEVICE, DRIVING ASSISTANCE METHOD, AND STORAGE MEDIUM

(71) Applicant: TOYOTA JIDOSHA KABUSHIKI KAISHA, Toyota-shi (JP)

(72) Inventors: Kazuhiro MORIMOTO, Toyota-shi (JP); Yusuke TANAKA, Toyota-shi (JP); Kohei TOSHIMA, Toyota-shi (JP); Motohiro FUKAYA, Nisshin-shi (JP)

(73) Assignee: TOYOTA JIDOSHA KABUSHIKI KAISHA, Toyota-shi (JP)

(21) Appl. No.: 19/439,758

(22) Filed: Jan. 5, 2026

(30) Foreign Application Priority Data
Mar. 27, 2025 (JP) 2025-053762

(51) Int. Cl. B60W 50/00; B60W 50/08

(52) U.S. Cl. CPC B60W 50/0098; B60W 50/082; B60W 2540/227; B60W 2552/00; B60W 2720/106

(57) ABSTRACT

A driving assistance control device for a vehicle is configured to: perform driving assistance including deceleration and stop control for decelerating the vehicle and maintaining the vehicle in a stopped state in response to determination that a driver of the vehicle is in an abnormal state in which the driver has difficulty in continuing to drive the vehicle; stop, when a permitted stopping and parking area along a roadside on a front passenger seat side of the vehicle is present on a road while the driving assistance is being performed, the vehicle in the permitted stopping and parking area with a certain space in a vehicle width direction between the vehicle and the roadside; and set, when a passenger is present in the vehicle, the space to be wider compared to when the passenger is not present in the vehicle.

### CROSS-REFERENCE TO RELATED APPLICATION

This application claims priority to Japanese Patent Application No. 2025-053762 filed on Mar. 27, 2025. The disclosure of the above-identified application, including the specification, drawings, and claims, is incorporated by reference herein in its entirety.

### BACKGROUND

### 1. Technical Field

The present disclosure relates to a driving assistance control device, a driving assistance method, and a storage medium.

### 2. Description of Related Art

Japanese Patent Application Publication No. 2021-109559 (JP 2021-109559 A) discloses a travel control device in the related art for a vehicle configured to determine whether a driver is in an abnormal state and, when the driver is in an abnormal state, to perform deceleration and stop control that decelerates a host vehicle and maintains the host vehicle in a stopped state. Japanese Unexamined Patent Application Publication No. 2021-115967 (JP 2021-115967 A) discloses a travel control device in the related art for a vehicle configured to start a pull-over travel control when a physical abnormality of a driver is detected, thereby causing the vehicle to pull over to the shoulder of the road.

### SUMMARY

However, the travel control device in the related art described above did not take a passenger into consideration. Therefore, for example, when the vehicle is caused to pull over to the shoulder of the road and stop when the driver is in an abnormal state, the vehicle may be stopped at the shoulder of the road without securing a distance in a vehicle width direction between the vehicle and a roadside such as a guardrail, that is, without securing a space for a passenger to exit from a front passenger seat side of the vehicle. Therefore, the passenger may be forced to exit from a driver's seat side of the vehicle (roadway side) with a risk of contact with another vehicle, and there is a possibility that the passenger may be unable to safely exit from the front passenger seat side of the vehicle.

The present disclosure has been made in view of such problems, and an object thereof is to enable a passenger to safely exit the vehicle when the driver falls into an abnormal state.

In order to solve the problem, a driving assistance control device of a vehicle according to an aspect of the present disclosure is configured to:

perform driving assistance including deceleration and stop control for decelerating the vehicle and maintaining the vehicle in a stopped state in response to determination that a driver of the vehicle is in an abnormal state in which the driver has difficulty in continuing to drive the vehicle;

stop, when a permitted stopping and parking area along a roadside on a front passenger seat side of the vehicle is present on a road while the driving assistance is being performed, the vehicle in the permitted stopping and parking area with a certain space in a vehicle width direction between the vehicle and the roadside; and

set, when a passenger is present in the vehicle, the space to be wider compared to when the passenger is not present in the vehicle.

In addition, a driving assistance method for a vehicle according to an aspect of the present disclosure includes:

performing driving assistance including deceleration and stop control for decelerating the vehicle and maintaining the vehicle in a stopped state in response to determination that a driver of the vehicle is in an abnormal state in which the driver has difficulty in continuing to drive the vehicle;

stopping, when a permitted stopping and parking area along a roadside on a front passenger seat side of the vehicle is present on a road while the driving assistance is being performed, the vehicle in the permitted stopping and parking area with a certain space in a vehicle width direction between the vehicle and the roadside; and

setting, when a passenger is present in the vehicle, the space to be wider compared to when the passenger is not present in the vehicle.

In addition, a storage medium according to an aspect of the present disclosure stores a computer program that causes a computer to execute:

performing driving assistance including deceleration and stop control for decelerating a vehicle and maintaining the vehicle in a stopped state in response to determination that a driver of the vehicle is in an abnormal state in which the driver has difficulty in continuing to drive the vehicle;

stopping, when a permitted stopping and parking area along a roadside on a front passenger seat side of the vehicle is present on a road while the driving assistance is being performed, the vehicle in the permitted stopping and parking area with a certain space in a vehicle width direction between the vehicle and the roadside; and

setting, when a passenger is present in the vehicle, the space to be wider compared to when the passenger is not present in the vehicle.

According to the aspects of the present disclosure, a passenger can safely exit from the front passenger seat side of the vehicle when the driver falls into an abnormal state.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of a vehicle according to an embodiment of the present disclosure; and

FIG. 2 is a flowchart illustrating an example of a driver-abnormal-state response driving assistance processing according to the embodiment of the present disclosure.

### DETAILED DESCRIPTION OF EMBODIMENTS

Hereinafter, an embodiment of the present disclosure will be described in detail with reference to the drawings. In the following description, the same reference numerals are given to the same constituent elements.

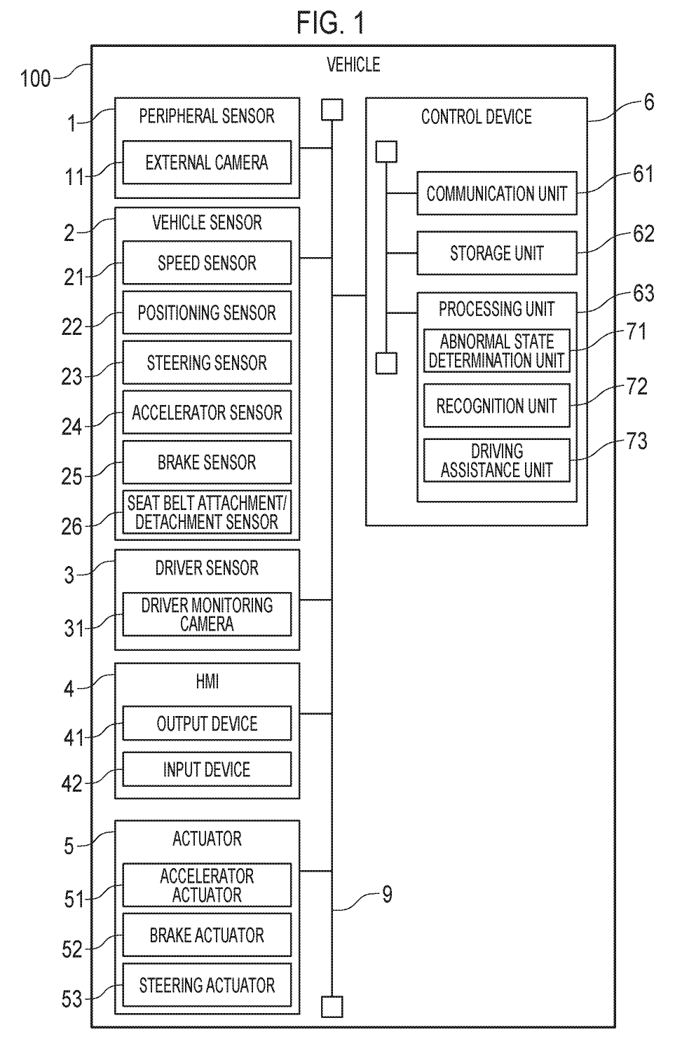

FIG. 1 is a schematic configuration diagram of a vehicle 100 according to the embodiment of the present disclosure.

The vehicle 100 includes a peripheral sensor 1, a vehicle sensor 2, a driver sensor 3, a human machine interface (HMI) 4, an actuator 5, and a control device 6. The peripheral sensor 1, the vehicle sensor 2, the driver sensor 3, the HMI 4, the actuator 5, and the control device 6 are communicably connected via an in-vehicle network 9 that conforms to a standard such as a controller area network.

The peripheral sensor 1 is a sensor for generating peripheral data representing a situation around the vehicle 100. The vehicle 100 according to the present embodiment includes one or more external cameras 11 for capturing an image of the periphery of the vehicle 100 as the peripheral sensor 1.

The external camera 11 captures an image of the periphery of the vehicle 100 at a predetermined frame rate (for example, 10 [Hz] to 40 [Hz]) and generates a peripheral image showing the periphery of the vehicle 100. Each time the external camera 11 generates the peripheral image, the generated peripheral image is transmitted to the control device 6 as the peripheral data.

In addition to the external camera 11, a distance measurement sensor that measures a distance to an object or a road feature present around the vehicle 100 may be provided as the peripheral sensor 1. Examples of the distance measurement sensor include a light detection and ranging (LiDAR) that emits laser light and measures a distance based on reflected light, and a millimeter wave radar sensor that emits radio waves and measures a distance based on reflected waves.

The vehicle sensor 2 is a sensor for acquiring vehicle data representing a state of the vehicle 100. The vehicle 100 according to the present embodiment includes a speed sensor 21 that acquires speed data indicating a traveling speed of the vehicle 100, a positioning sensor 22 that acquires current position data indicating a current position of the vehicle 100 such as latitude and longitude, and the like as the vehicle sensor 2. The vehicle 100 according to the present embodiment includes a steering sensor 23 that acquires steering data related to a steering operation such as a steering grip or a steering torque and a steering angle as the vehicle sensor 2. The vehicle 100 according to the present embodiment includes an accelerator sensor 24 that acquires accelerator data related to an accelerator operation such as an operation amount of an accelerator pedal, a brake sensor 25 that acquires brake data related to a brake operation such as an operation input of a brake pedal, and the like as the vehicle sensor 2. The vehicle 100 according to the present embodiment includes a seat belt attachment/detachment sensor 26 that acquires seat belt attachment/detachment data indicating an attachment/detachment state of a seat belt of the vehicle 100 as the vehicle sensor 2. However, the vehicle sensor 2 is not limited to these sensors. Each data acquired by each of the sensors 21 to 26 is transmitted to the control device 6 as the vehicle data.

The driver sensor 3 is a sensor for generating driver data representing a state of a driver. The vehicle 100 according to the present embodiment includes a driver monitoring camera 31 for capturing an image of a driver's appearance including a face of the driver as the driver sensor 3. The driver monitor camera 31 captures an image of the driver's appearance at a predetermined frame rate (for example, 10 [Hz] to 40 [Hz]) and generates an appearance image showing the driver's appearance. Each time the driver monitoring camera 31 generates the appearance image of the driver, the generated appearance image is transmitted to the control device 6 as the driver data.

The HMI 4 is a user interface for exchanging information between the vehicle 100 and an occupant of the vehicle 100. The HMI 4 includes an output device 41 for providing notifications to the vehicle occupant through the vehicle occupant's sensory modalities (for example, visual, auditory, and tactile senses), and an input device 42 through which the vehicle occupant performs an input operation or a response operation. The output device 41 is, for example, a display (for example, a meter display, a center display, a head-up display, or the like), a speaker, or the like. The input device 42 is, for example, a touch panel, a microphone, or the like.

The HMI 4 notifies the vehicle occupant of information corresponding to an output signal received from the control device 6 via the output device 41, and transmits data input by the vehicle occupant to the control device 6 via the input device 42.

The HMI 4 may be a device that is mounted in advance in the vehicle 100, or may be a terminal such as a smartphone owned by the vehicle occupants (driver and passenger). In the latter case, for example, information may be exchanged by performing short-range wireless communication between the vehicle 100 and the terminal of the vehicle occupant. Communication may be performed between the terminal of the vehicle occupant and an external server (not illustrated), and information may be exchanged indirectly via the server.

The actuator 5 is a device used for traveling control of the vehicle 100. The vehicle 100 according to the present embodiment includes an accelerator actuator 51 (for example, at least one of an engine or a motor) that performs acceleration control of the vehicle 100 as the actuator 5. The vehicle 100 according to the present embodiment includes a brake actuator 52 (for example, a hydraulic actuator) that performs brake control of the vehicle 100, and a steering actuator 53 (for example, a steering motor) that performs steering control of the vehicle 100.

The control device 6 is an electronic control unit (ECU) including a communication unit 61, a storage unit 62, and a processing unit 63.

The communication unit 61 includes an interface circuit for connecting the control device 6 to the in-vehicle network 9. The communication unit 61 supplies various types of data received from the outside to the processing unit 63. In addition, the communication unit 61 outputs various signals output from the processing unit 63 to the outside.

The storage unit 62 includes a storage medium such as a hard disk drive (HDD), a solid state drive (SSD), or a semiconductor memory, and stores various computer programs, data, and the like used for processing in the processing unit 63.

The processing unit 63 includes one or more central processing units (CPUs) and a peripheral circuit thereof, and executes various computer programs stored in the storage unit 62. The processing unit 63 is, for example, a processor. The processing unit 63 may further include other arithmetic circuits such as a logic operation unit, a numerical operation unit, or a graphics processing unit. The processing unit 63 functions as an abnormal state determination unit 71, a recognition unit 72, and a driving assistance unit 73 by executing processing in accordance with a computer program, and operates as functional units (modules) that realize predetermined functions. In the following description, when the processing is described with respective functional units 71 to 73 as the subject, each case shows that the processing unit 63 is executing a program that realizes each of the functional units 71 to 73.

Hereinafter, contents of specific processing performed in the control device 6 will be described. That is, contents of each of the functional units 71 to 73 realized by the processing unit 63 executing processing in accordance with the computer program will be described.

The abnormal state determination unit 71 determines whether the driver has fallen into an abnormal state (hereinafter, simply referred to as an "abnormal state") in which the driver has difficulty in continuing driving, for example, due to a sudden change in physical condition. In the present embodiment, the abnormal state determination unit 71 determines that the driver has fallen into the abnormal state when a predetermined abnormal estimation state continues for a predetermined determination time T1 [s].

The estimated abnormal state is a state in which it is considered that the driver has fallen into the abnormal state. Examples of the estimated abnormal state include a state in which the driver's eyes are closed, a state in which the posture of the driver has collapsed, and a state in which the steering is not being operated unless the driving assistance that allows hands-off driving is being performed. The state in which the posture of the driver has collapsed refers, for example, to a state in which the driver is slumped forward or bowed down due to muscle relaxation caused by loss of consciousness or the like. The state in which the posture of the driver has collapsed refers, for example, to a state in which the driver is arched backward, or the head or the upper body of the driver is tilted or fallen to the side, or a state in which the driver is arched due to rigidity caused by epilepsy or the like.

Whether the driver's eyes are closed, the posture of the driver has collapsed, or the steering is not being operated can be determined, for example, from the driver's appearance based on the image of the driver monitoring camera 31. In addition, as long as the data related to steering operation is acquired by the steering sensor 23, whether the steering is not being operated can be determined, for example, based on the data or based on the data and the image from the driver monitoring camera 31.

The recognition unit 72 recognizes an object and a road feature around the vehicle 100. The recognition unit 72 recognizes, in the peripheral image, both an object such as another vehicle, a two-wheeled vehicle, or a pedestrian, and a road feature such as a curb or a fence or other similar structure (hereinafter, referred to as a "partition structure") or a road sign (for example, a lane marking defining a travel lane) by sequentially inputting the peripheral image received from the external camera 11 to an identifier. The identifier can be, for example, a convolutional neural network (CNN) having a plurality of convolutional layers connected in series from an input side to an output side. In addition, the recognition unit 72 calculates a distance from the vehicle 100 to the object and the road feature and calculates a position of the object and the road feature by using, for example, a standard size of the object and the road feature stored in the storage unit 62 for each type of the object and the road feature and a size of the object and the road feature recognized in the peripheral image. The method of recognizing the object and the road feature is not limited to such a method, and may be recognized by various known methods.

The driving assistance unit 73 controls the actuator 5 based on the object and the road feature recognized by the recognition unit 72 to perform driving assistance involving travel control of the vehicle 100. In the present embodiment, the driving assistance unit 73 can perform driving assistance involving travel control of the vehicle 100 at a driving control level of level 3 defined by the Society of Automotive Engineers (SAE). That is, the driving assistance unit 73 can perform driving assistance involving travel control of the vehicle 100 at a driving control level that does not require the driver to operate each of the actuators 51 to 53 and to monitor the periphery. In addition, the driving assistance unit 73 can perform driving assistance involving travel control of the vehicle 100 at a driving control level in which the driver is involved in driving the vehicle 100, for example, a driving control level of level 1 or level 2 defined by SAE.

As one type of the driving assistance involving traveling control of the vehicle 100, the driving assistance unit 73 performs driver-abnormal-state response driving assistance to respond to the abnormal state of the driver when it is determined that the driver has fallen into the abnormal state. Specifically, when it is determined that the driver has fallen into the abnormal state, the driving assistance unit 73 first performs notification control to notify the driver of a control warning (alarm) to the driver via the HMI 4. After a predetermined time T2 [s] has elapsed from the start of the notification, the vehicle 100 is decelerated to perform deceleration and stop control in which the vehicle 100 is maintained in a stopped state. That is, the driver-abnormal-state response driving assistance includes the notification control and the deceleration and stop control including deceleration control and stop-maintaining control. In addition, the driving assistance unit 73 executes a measure (for example, turning on the hazard lights) for notifying a peripheral vehicle of the abnormality of the driver of the vehicle 100 during the driver-abnormal-state response driving assistance.

In a case of performing the deceleration and stop control, in order to reduce a risk of contact between the host vehicle and a following vehicle, it is desirable, when a stoppable or parkable area along a roadside on a front passenger seat side of a road (hereinafter, referred to as a "pull-over area") is present, to cause the vehicle to pull over to the pull-over area instead of stopping the vehicle in a travel lane. The pull-over area refers to, for example, a shoulder or a roadside strip where parking or stopping is not prohibited.

In this case, when the passenger is not present, in consideration of the risk of contact between the host vehicle and the following vehicle, it is desirable to cause the vehicle to stop in the pull-over area by making the space (distance) in the vehicle width direction between the host vehicle and the roadside as narrow as possible.

However, a protective fence such as a guardrail may be installed at the roadside. Therefore, when the passenger is present, the vehicle is stopped at the shoulder area without securing the space in the vehicle width direction between the host vehicle and the roadside, that is, without securing the space for the passenger to exit the vehicle from the front passenger seat side. In this case, the passenger may be forced to exit the vehicle from the driver's seat side (roadway side) with a risk of contact with another vehicle, and there is a possibility that the passenger may be unable to safely exit the vehicle from the front passenger seat side (sidewalk side).

Therefore, in the present embodiment, when the vehicle is caused to stop in the pull-over area, the space in the vehicle width direction between the host vehicle and the roadside is changed depending on the presence or absence of the passenger. Specifically, when the passenger is present, the space in the vehicle width direction between the host vehicle and the roadside is set wider, compared to when the passenger is not present, so that the space for the passenger to exit the vehicle from the front passenger seat side can be secured. As a result, when the passenger is present, the passenger can safely exit the vehicle from the front passenger seat side (sidewalk side) by securing the space for exiting the vehicle instead of the driver's seat side (roadway side). On the other hand, when the passenger is not present, the vehicle can be caused to stop as close to the roadside as possible, so that the risk of contact with the following vehicle can be reduced.

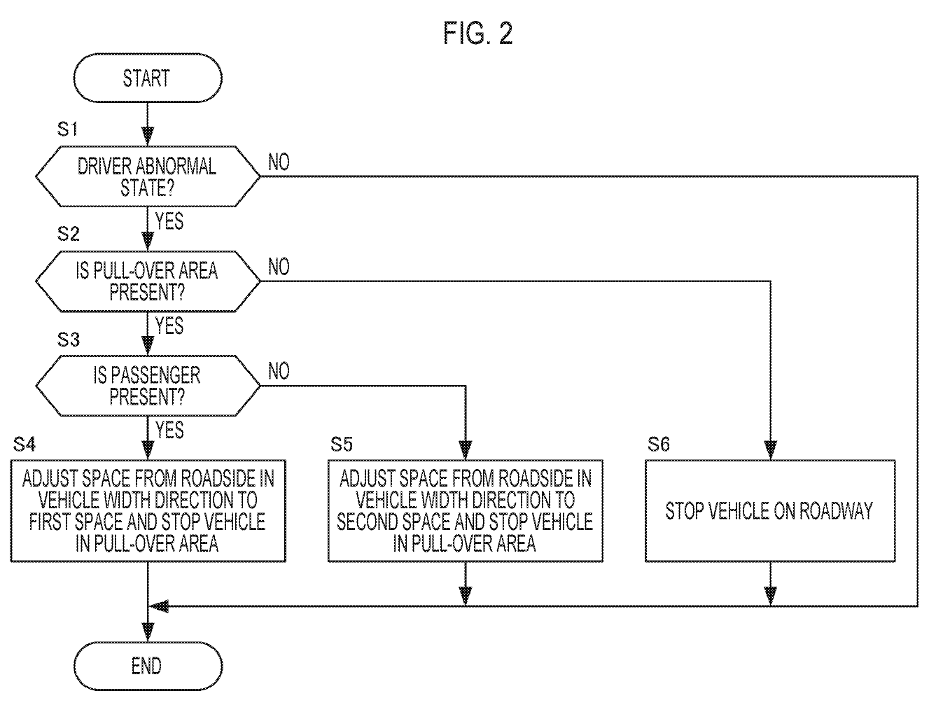

FIG. 2 is a flowchart illustrating an example of the driver-abnormal-state response driving assistance processing executed by the driving assistance unit 73 and, by extension, the control device 6.

In S1, the control device 6 determines whether the driver has fallen into the abnormal state. When the driver has fallen into the abnormal state, the control device 6 proceeds to the processing of S2. On the other hand, when the driver has not fallen into the abnormal state, the control device 6 ends the current processing.

In S2, the control device 6 determines whether the pull-over area is present. In the present embodiment, the control device 6 determines whether the pull-over area is present based on the recognition result of the road feature (partition structure or lane marking of the road) by the recognition unit 72. However, the method of determining whether the pull-over area is present is not particularly limited, and for example, the determination can be made by also considering map information in addition to the recognition result of the road feature by the recognition unit 72. When the pull-over area is present in front of the host vehicle, the control device 6 proceeds to the processing of S3. On the other hand, when the pull-over area is not present in front of the host vehicle, the control device 6 proceeds to the processing of S6.

In S3, the control device 6 determines whether the passenger is present. In the present embodiment, the control device 6 determines whether the passenger is present based on the seat belt attachment/detachment data, but the method of determining whether the passenger is present is not particularly limited. For example, when an in-vehicle camera that captures an image of the occupant of the front passenger seat or the rear seat is provided, the determination can be made based on the captured image of the in-vehicle camera, and when a seat occupancy sensor is provided, the determination can be made based on the detection data of the seat occupancy sensor. When the passenger is present, the control device 6 proceeds to the processing of S4. On the other hand, when the passenger is not present, the control device 6 proceeds to the processing of S5.

In S4, the control device 6 causes the host vehicle to pull over to the pull-over area after the notification control, adjusts the space in the vehicle widthdirection between the host vehicle and the roadside to a first space that is predetermined, and maintains the host vehicle in the stopped state. The first space is a space that allows the passenger to exit the vehicle from the front passenger seat side, and is a space that is determined in advance for each vehicle depending on the manner in which the door on the front passenger seat side is opened. The first space is set to be wider than a second space (space set for causing the host vehicle to stop as close to the roadside as possible) described below.

In S5, the control device 6 causes the host vehicle to pull over to the pull-over area after the notification control, adjusts the space in the vehicle width direction between the host vehicle and the roadside to a second space that is predetermined, and maintains the host vehicle in the stopped state. The second space is a space that is determined in advance for causing the host vehicle to stop as close to the roadside as possible. Therefore, the second space is set to be narrower than the first space that is set to secure the space for exiting the vehicle.

In S6, the control device 6 maintains the host vehicle in the stopped state on the roadway after the notification control. For example, when the lane marking of the travel lane of the host vehicle can be recognized, the control device 6 decelerates the vehicle 100 along the lane marking of the travel lane of the host vehicle and maintains the vehicle 100 in the stopped state. For example, when the lane marking of the travel lane of the host vehicle cannot be recognized, the control device 6 decelerates the vehicle 100 along the trajectory of the preceding vehicle and maintains the vehicle 100 in the stopped state. For example, when the lane marking of the travel lane of the host vehicle and the preceding vehicle cannot be recognized, the control device 6 decelerates the vehicle 100 while causing the vehicle 100 to move straight and maintains the vehicle 100 in the stopped state.

The control device 6 (driving assistance control device) of the vehicle 100 according to the present embodiment is configured to perform the driver-abnormal-state response driving assistance (driving assistance) including the deceleration and stop control of decelerating the vehicle 100 and maintaining the vehicle 100 in the stopped state in response to a determination that the driver of the vehicle 100 is in an abnormal state in which the driver has difficulty in continuing to drive the vehicle 100. The control device 6 (driving assistance control device) of the vehicle 100 is configured to stop, when the pull-over area where stopping and parking are permitted along the roadside on the front passenger seat side of the vehicle 100 is present on the road while the driver-abnormal-state response driving assistance is being performed, the vehicle 100 in the pull-over area with a space that is predetermined in the vehicle width direction between the vehicle 100 and the roadside, and set, when the passenger is present in the vehicle 100, the space to be wider, compared to when the passenger is not present in the vehicle 100.

Specifically, the control device 6 is configured to set, when the passenger is present in the vehicle 100, the space in the vehicle width direction between the vehicle 100 and the roadside to a space that allows the passenger to exit the vehicle from the front passenger seat side of the vehicle 100, and set, when the passenger is not present in the vehicle 100, the space to be narrower than the space that allows the passenger to exit the vehicle from the front passenger seat side of the vehicle 100.

As a result, when the passenger is present, the passenger can safely exit the vehicle from the front passenger seat side (sidewalk side) by securing the space for exiting the vehicle instead of the driver's seat side (roadway side). On the other hand, when the passenger is not present, the vehicle 100 can be caused to stop as close to the roadside as possible, so that the risk of contact between the vehicle 100 and the following vehicle can be reduced.

Although the embodiments of the disclosure have been described above, the above embodiments merely show a part of application examples of the disclosure, and are not intended to limit the technical scope of the disclosure to the specific configurations of the embodiments.

For example, in the above-described embodiments, the computer program executed by the control device 6 may be provided in the form of being recorded on a computer-readable portable recording medium such as a semiconductor memory, a magnetic recording medium, or an optical recording medium, or may be provided as a computer program product.

What is claimed is:

1. A driving assistance control device for a vehicle, the driving assistance control device being configured to:
perform driving assistance including deceleration and stop control for decelerating the vehicle and maintaining the vehicle in a stopped state in response to determination that a driver of the vehicle is in an abnormal state in which the driver has difficulty in continuing to drive the vehicle;
stop, when a permitted stopping and parking area along a roadside on a front passenger seat side of the vehicle is present on a road while the driving assistance is being performed, the vehicle in the permitted stopping and parking area with a certain space in a vehicle width direction between the vehicle and the roadside; and
set, when a passenger is present in the vehicle, the space to be wider compared to when the passenger is not present in the vehicle.

2. The driving assistance control device according to claim 1, wherein, when the passenger is present in the vehicle, the space is set to a space that allows the passenger to exit from the front passenger seat side of the vehicle.

3. The driving assistance control device according to claim 1, wherein, when the passenger is not present in the vehicle, the space is set to be narrower than a space that allows the passenger to exit from the front passenger seat side of the vehicle.

4. A driving assistance method for a vehicle, the driving assistance method comprising:
performing driving assistance including deceleration and stop control for decelerating the vehicle and maintaining the vehicle in a stopped state in response to determination that a driver of the vehicle is in an abnormal state in which the driver has difficulty in continuing to drive the vehicle;
stopping, when a permitted stopping and parking area along a roadside on a front passenger seat side of the vehicle is present on a road while the driving assistance is being performed, the vehicle in the permitted stopping and parking area with a certain space in a vehicle width direction between the vehicle and the roadside; and
setting, when a passenger is present in the vehicle, the space to be wider compared to when the passenger is not present in the vehicle.

5. A non-transitory storage medium storing a computer program that causes a computer to execute:
performing driving assistance including deceleration and stop control for decelerating a vehicle and maintaining the vehicle in a stopped state in response to determination that a driver of the vehicle is in an abnormal state in which the driver has difficulty in continuing to drive the vehicle;
stopping, when a permitted stopping and parking area along a roadside on a front passenger seat side of the vehicle is present on a road while the driving assistance is being performed, the vehicle in the permitted stopping and parking area with a certain space in a vehicle width direction between the vehicle and the roadside; and
setting, when a passenger is present in the vehicle, the space to be wider compared to when the passenger is not present in the vehicle.
